(19) United States
(12) Patent Application Publication
(10) Pub. No.: US 2004/0139577 A1
(43) Pub. Date: Jul. 22, 2004

(54) Hinge

(76) Inventor: Rudiger Walz, Haigerloch (DE)

Correspondence Address: Friedrich Kueffner, Suite 910, 317 Madison Avenue, New York, NY, 10017, US

(21) Appl. No.: 10/704,373

(22) Filed: Nov. 7, 2003

(30) Foreign Application Priority Data
Nov. 7, 2002 (DE) 202 17 184.1

(51) Int. Cl. E05D 5/02

(52) U.S. Cl. 16/252

(57) ABSTRACT

A hinge including a base body and a pivoting component pivotally mounted on the base body. The pivoting component is constructed as a pivotable tightening bolt which can be placed in a bore and tightened by a corresponding clamping part.

### BACKGROUND OF THE INVENTION

1. Field of the Invention

The present invention relates to a hinge including a base body and a pivoting component pivotally mounted on the base body.

2. Description of the Related Art

In known hinges of this type, the base body is fastened to a first furniture element by means of two or three screws. The pivoting component which is pivotally connected to the base body is known to be a plate which can be screwed to a second furniture element by means of three screws. The assembly and disassembly of such a hinge is complicated because the plate must be screwed to and unscrewed from the second furniture element. Moreover, it has been found to be difficult to position the furniture elements correctly relative to each other and to hold the furniture in this position during the assembly.

### SUMMARY OF THE INVENTION

Therefore, it is the object of the present invention to further develop the hinge described above in such a way that the assembly and disassembly can take place more easily.

In accordance with the present invention, the pivoting component is constructed as a pivotable tightening bolt which can be tightened by a corresponding clamping part.

The base body is fastened to a first element, for example, a furniture plate or a window frame, and the tightening bolt is inserted into an end face bore at the end face of a second element, for example, a second furniture plate or a window, to be pivotally connected to the first element. The clamping part is arranged so as to be rotatable in a bore at the end of the end face bore of the second element. By actuating the clamping part, the tightening bolt is tightened and locked in the tightened position. Consequently, it is not necessary to screw the pivoting component to the second element. For effecting the disassembly, it is only necessary to transfer the clamping component into its released position. The second element can then be pulled off from the tightening bolt. The end face bore of the second element determines the positioning of the two elements. Accordingly, for effecting the assembly, it is only necessary to insert the tightening bolt into the end face bore and to transfer the clamping part into its locked position. When the tightening bolt is tightened, the two elements are automatically positioned correctly relative to each other.

In accordance with a preferred embodiment, the tightening bolt has a tightening bolt head which is at least partially engaged from behind by the clamping part in its locked position. As a result of this measure, the tightening bolt can be pulled off particularly easily when the clamping part is transferred from its released position into its locked position. In the locked position, the tightening bolt is engaged from behind by the clamping part, so that the second element is held tightly, particularly without play, at the hinge.

In accordance with a preferred feature, the base body includes a stop. The base body is inserted into a recess of the first element. If the recess has been made too deep, the stop prevents the base body from being inserted too far. The stop insures that the base body is correctly positioned in the first element.

If the base body has laterally in a tightening bolt receiving means a passage opening for receiving a fastening means, it is possible to insert a fastening means, for example, a screw, in an inclined position. On the one hand, this causes the base body to be securely fastened to the first element, and, on the other hand, the inserted fastening means is hardly visible.

By constructing the base body so as to have an oblong shape, the slender and space-saving configuration of the base body makes it particularly suitable for use in windows and window frames, particularly those of aluminum.

In accordance with a preferred embodiment, at least one fastening means receiving means is provided so as to be accessible exclusively from a rear side of the base body. If the fastening means receiving means is provided at the rear side, then the base body can be mounted on the first element, for example, an aluminum window, in such a way that the fastening means are located so as to be invisible and the visual impression of the hinge is improved.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is an exploded view of a first embodiment of the hinge according to the present invention;

FIG. 2 is a perspective view of the hinge of FIG. 1 with a pivoted pivoting component;

FIG. 3 is a sectional view of the hinge of FIGS. 1 and 2, shown in the assembled state;

FIG. 4 is a perspective view of a second embodiment of the hinge according to the present invention.

### DESCRIPTION OF THE PREFERRED EMBODIMENTS

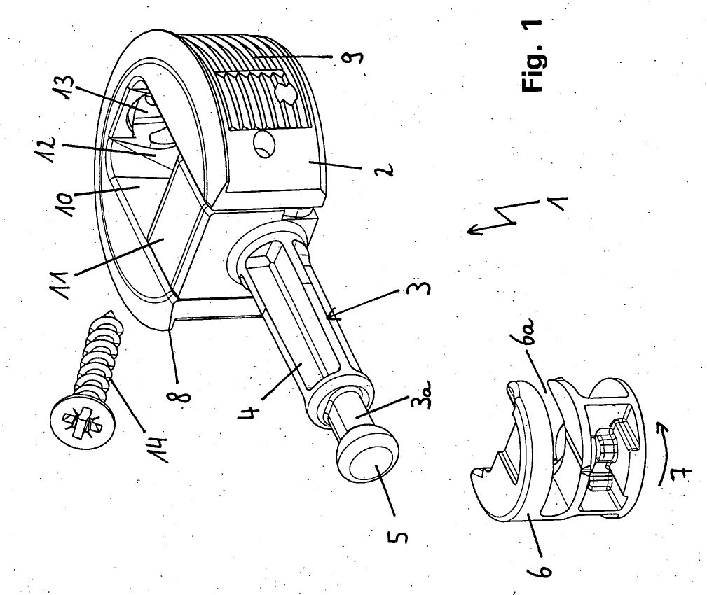

FIG. 1 of the drawing shows a first embodiment of a hinge 1 which includes a base body 2 and a pivoting component which is constructed as a tightening bolt 3 and is pivotally connected to the base body 2. The tightening bolt 3 includes a tightening bolt shaft 4 and a tightening bolt head 5. The tightening bolt head 5 can be inserted into a corresponding cylindrical clamping part 6. By actuating the clamping part 6 in the direction of arrow 7, the clamping part 6 is transferred from a released position into a locking position, so that a neck portion 3a having an essentially oval cross-section comes to rest in a slot 6a and the inserted tightening bolt head 5 is engaged from behind and is tightened. The base body 2 includes a stop 8 which prevents the base body 2 from being inserted too far into a recess of a first element, for example, a furniture plate. Ribs 9 at the outer circumference prevent the base body 2 from falling out of the recess before or during fastening of the base body 2 at the first element. The tightening bolt 3 is supported in a tightening bolt receiving means 10 into which a holding section 11 of the tightening bolt 3 pivots when the tightening bolt is pivoted. Located on the side of the tightening bolt receiving means 10 opposite the holding section 11, an inclined surface 12 is arranged which includes a passage opening 13 for receiving a fastening means 14 constructed as a screw. The passage opening 13 guides the fastening means 14 in such a way that it is inserted into the first element in an inclined position.

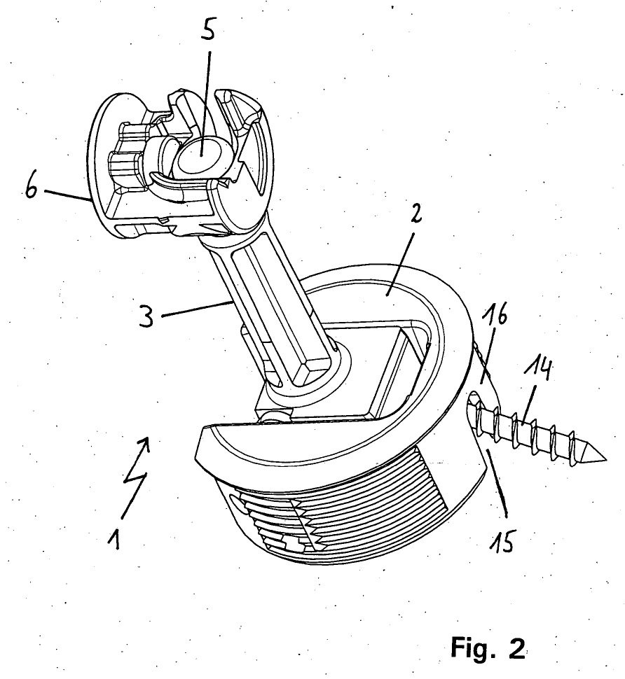

FIG. 2 shows the hinge 1 of FIG. 1. The tightening bolt 3 has been pivoted as compared to the position shown in FIG. 1. The clamping part 6 has been turned into its locked position and engages behind the tightening bolt head 5. The fastening means 14 is inserted into the passage opening and protrudes in an inclined position out of a slot 15 in the side wall 16 of the base body 2. Because of the presence of the slot 15, the inclined position of the fastening means 14 can be freely selected within certain limits.

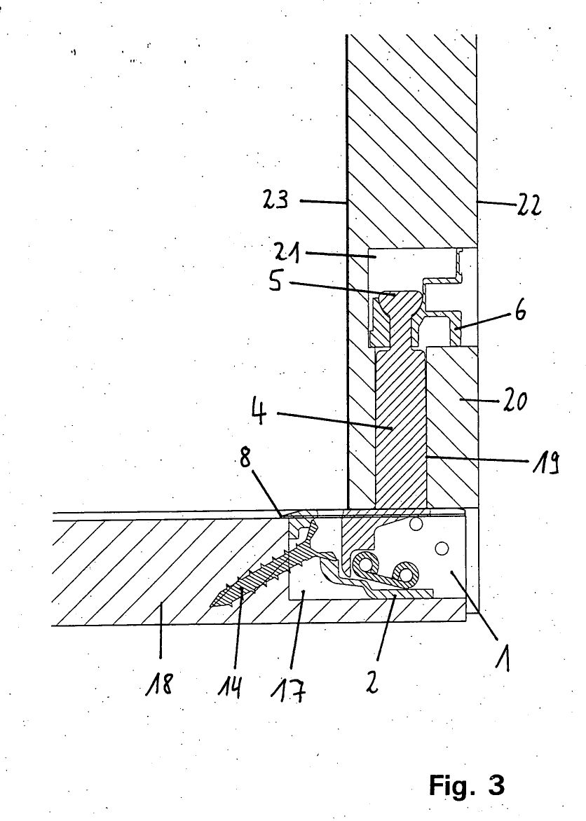

FIG. 3 is a sectional view of the hinge 1 of FIGS. 1 and 2. The base body 2 is arranged in a recess 17 of a first element 18. The stop 8 prevents the base body 2 from further penetrating into the recess 17 of the first element 18. The base body 2 is held in the first element 18 by the fastening means 14. The tightening bolt shaft 4 is mounted in an end face bore 19 of a second element 20. The tightening bolt head 5 protrudes into a bore 21 of the second element 20 and is engaged from behind in the bore 21 by the clamping part 6 rotatably mounted in the board 21, wherein the clamping part 6 is in the locked position. The bore 21 is accessible from the rear side 22 of the second element 20, so that, when looking at the front side 23 of the second element 20, it cannot be seen how the second element 20 is fastened to the hinge 1.

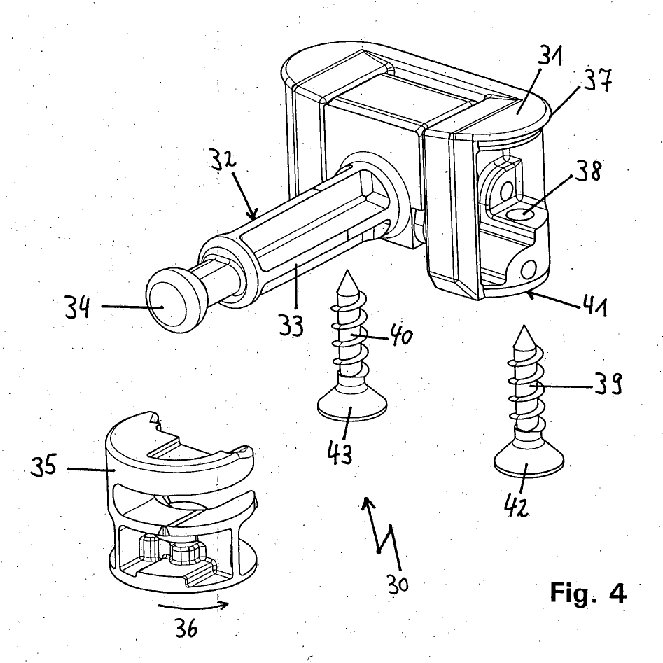

FIG. 4 shows a second embodiment of a hinge 30 which includes a base body 31 and a pivoting component constructed as a tightening bolt 32 and pivotally connected to the base body 31. The tightening bolt 32 includes a tightening bolt shaft 33 and a tightening bolt head 34. The tightening bolt head 34 can be inserted into a corresponding cylindrical clamping component 35. By actuating the clamping component 35 in the direction of arrow 36, the clamping component 35 is transferred from a released position into a locked position, so that the inserted tightening bolt head 34 is engaged from behind and tightened. The base body 31 includes a stop 37 which prevents the base body 31 from being inserted too far into a recess of a first element, for example, an aluminum window. The base body 31 has an oblong shape, so that it is suitable for use in windows or similar objects in which the mounting space is limited. Fastening means receiving means 38 are provided in the base body 31, wherein fastening means 39, 40 constructed as screws can be held in the receiving means 38. The base body 31 is inserted from the visible side into the recess of the first element. In the illustrated embodiment, the fastening means 39, 40 are screwed in from the rear side 41 of the base body 31, wherein, when the base body 31 is fastened, a portion of the first element is located between the base body 31 and the fastening means heads 42, 43.

While specific embodiments of the invention have been shown and described in detail to illustrate the inventive principles, it will be understood that the invention may be embodied otherwise without departing from such principles.

I claim:

1. A hinge comprising a base body and a pivoting component pivotally mounted on the base body, and a clamping component adapted to be rotatably placed in a bore, wherein the pivoting component is a pivotable tightening bolt which is engaged and tightened by the clamping component.

2. The hinge according to claim 1, wherein the tightening bolt includes a holding section which is pivotally mounted in a tightening bolt receiving means.

3. The hinge according to claim 1, wherein the base body comprises a stop.

4. The hinge according to claim 3, wherein the base body comprises laterally in a tightening bolt receiving means a passage opening for receiving a fastening means.

5. The hinge according to claim 1, wherein the base body has an oblong shape.

6. The hinge according to claim 5, comprising at least one fastening means receiving means which is exclusively accessible from a rear side of the base body.

7. The hinge according to claim 1, wherein the tightening bolt has at least over sections thereof an essentially oval cross-section.
